(19) United States
(12) Patent Application Publication
(10) Pub. No.: US 2007/0005153 A1
(43) Pub. Date: Jan. 4, 2007

(54) Device and method for administering data related to a complex object

(76) Inventor: Steffen Schwarz, Braunschweig (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/378,509

(22) Filed: Mar. 17, 2006

(30) Foreign Application Priority Data
Mar. 21, 2005 (DE) DE1020050129706

(51) Int. Cl. G05B 13/02

(52) U.S. Cl. 700/30

(57) ABSTRACT

An example embodiment relates to a device and a method for administering data that are related to a complex object composed of a plurality of components when said complex object is modified, wherein at least a portion of the components goes through a series of assembly stages during this modification. The interrelationships of the components may be recorded in a databank by means of relationship data for each assembly stage.

### CLAIM OF PRIORITY

The present patent application claims the priority benefit of the filing date of European Application DE 10 2005 012970.6 filed Mar. 21, 2005, the entire content of which is incorporated herein by reference.

### TECHNICAL FIELD

The present disclosure relates to a device for administering data that are related to a complex object comprising a plurality of components when said complex object is modified. During this modification at least a portion of the components goes through a series of assembly stages.

### DESCRIPTION OF THE RELATED ART

A complex object, such as a motor vehicle, consists of several thousand components. There are several variants for each component so that the number of component combinations that a motor vehicle can comprise is very high. The components that make up the motor vehicle are recorded on a parts list. A plurality of relevant details is stored on the parts list for each component.

When a motor vehicle or a part of a motor vehicle, for example, of an assembly of several components, is developed, some components must be modified. Each component usually goes through a series of assembly stages before it reaches the final stage in the developed motor vehicle. In the development phase, this can result in the problem that not every assembly stage of a developed component is compatible with the present components or certain assembly stages of other developed components. If, for example, it is intended to build a prototype of the assembly in the development phase, the problem arises that one does not know whether the current assembly stages of the respective components of the assembly are even compatible. In cases where the current assembly stages are not compatible, one further does not know which assembly stages are compatible with which components.

A method for determining the effects of manufacturing modifications is known from DE 101 29 654. The method is employed in particular in tolerance planning. By way of this method, incompatibilities in tolerance modifications or subsequent modified constructions can be minimized. The above-mentioned problems in developing complex objects or assemblies are, however, not solved.

### BRIEF DESCRIPTION OF THE DRAWINGS

In the following the invention is illustrated by way of an embodiment with reference to the drawings.

FIG. 1 schematically shows an embodiment of the device according to an example embodiment and

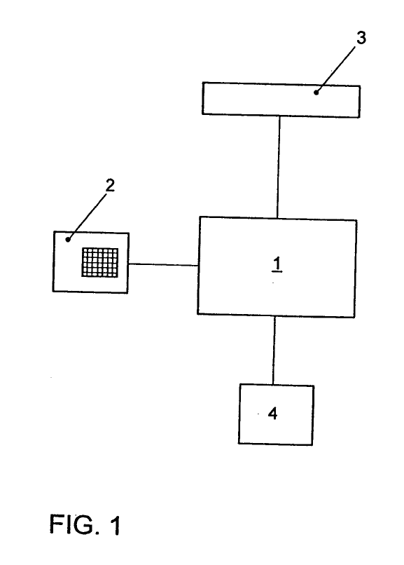

FIG. 2 schematically shows the relationship matrix with the relationship data stored in the databank.

### DETAILED DESCRIPTION

The device according to an example embodiment is characterized by a databank in which the interrelationships of the components are recorded for each assembly stage by means of relationship data. During the development of a component, its relationship to each assembly stage of the other components is recorded for each assembly stage of its own. This way the current assembly stages of the components can be readily compared with one another with regard to their interrelationships. A manual comparison of different part lists kept independently of one another is not necessary. The device according to an example embodiment can thus be particularly advantageously employed in documenting the development of the complex object and in building a prototype.

According to an example embodiment of the device, the relationship data contain information on whether a component is attached to another component in the assembled complex object. The attachment of two components to each other represents a direct relationship between these components. If the geometry of one component is modified, then in many cases the geometry of the other component must also be modified. Furthermore, a modification of the material of a component can affect the material of the other component, depending on the nature of the attachment.

According to a further example embodiment of the device, the relationship data contain information on whether a component possesses a surface that is contiguous with a surface of another component in the assembled complex object. This kind of relationship between two components is particularly important when the geometry of one component is modified in the area of the surface that is contiguous with the other component.

According to yet another example embodiment of the device, the relationship data contain information on whether a component is arranged in the vicinity of another component in the assembled complex object so that the modification of first component affects the second component in the vicinity of the first component. If only a part of the complex object, for example an assembly, is considered, then it is often important to know how the area around the assembly is designed so as to be able to determine how modifications of the components of the assembly affect or tolerate the components in the vicinity of the assembly.

This information is advantageously recorded in the relationship data for each assembly stage of the first component and for each assembly stage of the second component.

According to an example embodiment of the device, if there is a relationship between two components, the ability of the first component to combine with the second component is recorded in the databank for each assembly stage. This way, when developing the complex object, one can easily evaluate which of the respective assembly stages of the components are compatible with which, in order to, for example, build a prototype.

The device may comprise, in an example embodiment, a calculation unit connected to the databank as well as an output unit. The assembly stages of the components out of which the complex object can be assembled can be calculated with the calculation unit. For example, for an assembly stage of a component, those assembly stages of the remaining components of the complex object out of which the complex object can be assembled can be calculated with the calculation unit.

In one example embodiment, the successive assembly stages of a component are recorded in the databank. Furthermore, the successive assembly stages of the complex object can be recorded. This option facilitates the tracking of the different steps in the development not only of the components but of the complex object.

The method according to an example embodiment is characterized in that the interrelationships of the components are recorded in a databank for each assembly stage by means of relationship data. The recordal of this data facilitates subsequent evaluation during the development of the complex object. The relationship data recorded in the databank contain the aforementioned information on the attachment of components, contiguous surfaces and the vicinity of the components for each assembly stage of the respective components.

The device according to an example embodiment and the method according to an example embodiment aid in the administration of data when a complex object is modified. The complex object is composed of a plurality of components. If the complex object is a motor vehicle, the components are all parts that make up a motor vehicle. For these components there usually exists a so-called parts list, on which data such as part number, weight, material, supplier, are recorded for each component. Several components can be arranged to form an assembly. Such an assembly is, for example, a vehicle seat. This also is a complex object.

The embodiment described in the following relates to the administration of data resulting from the development of a motor vehicle. For example, a vehicle seat is being developed. This seat is composed of a plurality of components for each of which there can be several variants. The seat is to be integrated in the motor vehicle so there are motor vehicle parts in the vicinity of the seat that possibly have to be taken into account when components of the seat are modified. The device and the method described in the following provide for a documentation of the development and assembly stages of the components and corresponding assemblies. The work involved in manual documentation is reduced significantly by means of the device and method, in particular when components are modified frequently and at short notice and when the object is complex.

The device comprises an input unit 3 via which data can be entered manually. The input unit 3 can also, or alternatively, possess an interface for electronic data transmission from other units.

The input unit 3 is connected to the calculation unit 1, which accesses a memory 2. The memory 2 contains a parts list of the components of the complex object as well as a relationship matrix with relationship data of the components for each assembly or development stage. The data stored in the memory 2 can be modified by way of the calculation unit 1 and the input unit 3.

Moreover, the calculation unit can conduct evaluations that can be outputted via the output unit 4. The output unit 4 can be, for example, a screen or an interface to other units to which the output data are to be electronically transmitted.

In the following, the case of the development of an assembly, such as e.g. a vehicle seat, is considered.

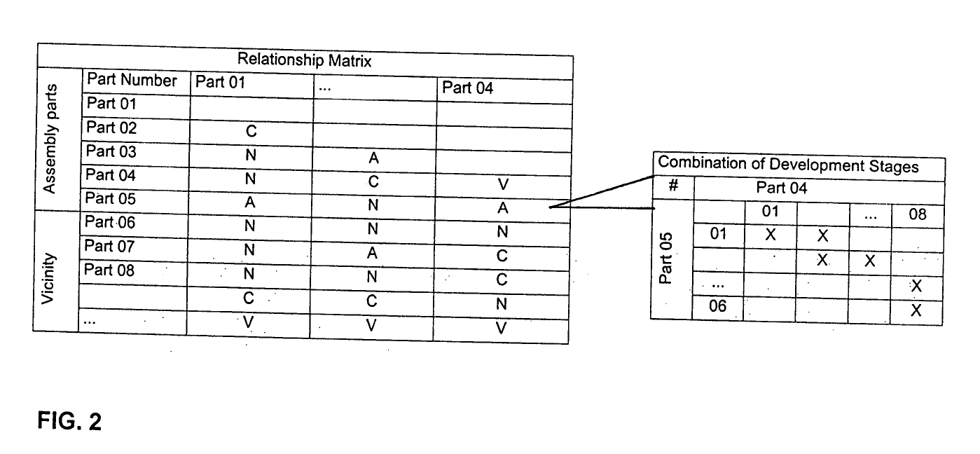

First, a relationship matrix is established in which relationship data for the components of the assembly and the complete parts list of the complex object, i.e. of the motor vehicle in this case, are recorded. This relationship matrix is stored in the memory 2. FIG. 2 shows an example of such a relationship matrix. The parts of the motor vehicle parts list are shown in the second vertical column, the parts of the assembly, i.e. e.g. of the vehicle seat, being listed before the parts that are arranged in the vicinity of the assembly. The second horizontal line of the relationship matrix contains the parts of the assembly.

There can be four different relationships between the respective components recorded in the relationship matrix. First, two parts can be attached to each other. In this case, an A is entered into the relationship matrix. Second, the two components can have contiguous surfaces. This is noted with a C in the relationship matrix. Third, a component can be arranged in the vicinity of another component so that the modification of the first component affects the second component. This is noted with a V in the relationship matrix. Finally, the possibility exists that a component is not affected by modifications of another component. This is noted with an N in the relationship matrix.

In the course of the development of the assembly, a portion of the components of the assembly is modified step by step, i.e. it goes through a series of assembly or development stages. In the example shown in FIG. 2, e.g. part 05 goes through the assembly stages 01 to 06, while the part 04 passes through the assembly stages 01 to 08. It is then recorded in a submatrix of the relationship matrix for each assembly stage of each component whether a given assembly stage of a component can be combined with an assembly stage of another component. In the submatrix shown in FIG. 2, an x means that the respective assembly stages of the respective parts can be combined, while a blank means that the respective assembly stages are not compatible. If the submatrix concerns the relationship “attachment” between two parts, a number is also indicated. Thus, a qualitative link between all components is established. Moreover, all assembly stages of two related components are placed in relation to each other.

If e.g. the development stage of the part 05 is changed from assembly stage 01 to assembly stage 02, the submatrix of the relationship matrix in the memory 2 is modified by the input unit 3 so that the part 05 with the assembly stage 01 can no longer be combined with the assembly stage 01 of the part 04, yet can still be combined with the next assembly stage of the part 04 as well as with the assembly stage of part 04 after that. These modifications are recorded at every new assembly stage of each component on the basis of the relationship data contained in the relationship matrix. Moreover, it is recorded when the type of relationship between two parts changes. It is, for example, possible that a part is no longer attached to another part, but rather now merely possesses a surface contiguous with a surface of the other part.

By accessing the databank stored in the memory 2 by means of the calculation unit 1, it is possible to conduct evaluations that are important for the development of the assembly automatically and very simply. For example, the assembly stages of the components out of which the complex object or assembly can be built can be calculated by means of the calculation unit 1. This calculation is only possible because it is recorded for the individual assembly stages whether or not they can be combined with the assembly stages of other components. For example, the most current assembly stage of a component can be entered, and the assembly stages of the remaining components of the assembly or complex object out of which the object or assembly can be built can be calculated by means of the calculation unit 1. This information is, for example, very important when a prototype is to be built.

Further, the calculation unit can show the history of a component, i.e. the successive assembly stages of this component. Moreover, the history of the complex object or of an assembly in this complex object can be shown. Finally, criteria such as cost and earliest possible date of manufacture can be taken into account in the evaluation.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Reference List
1Calculation Unit
2Memory
3Input Unit
4Output Unit

What is claimed is:

1. Device for administering data that are related to a complex object comprising a plurality of components when said complex object is modified, wherein at least a portion of the components goes through a series of assembly stages, wherein the device comprises a databank in which the interrelationships of the components are recorded for each assembly stage by means of relationship data.

2. Device according to claim 1 wherein the relationship data contain information on whether a component is attached to another component in the assembled complex object.

3. Device according to claim 1, wherein the relationship data contain information on whether a component possesses a surface that is contiguous with another component in the assembled complex object.

4. Device according claim 1, wherein the relationship data contain information on whether a component is arranged in the vicinity of another component in the assembled complex object so that the modification of the first component affects the second component in the vicinity of the first component.

5. Device according to claim 2, wherein the information in the relationship data is recorded for each assembly stage of the one component and for each assembly stage of the other component.

6. Device according to claim 3, wherein the information in the relationship data is recorded for each assembly stage of the one component and for each assembly stage of the other component.

7. Device according to claim 4, wherein the information in the relationship data is recorded for each assembly stage of the one component and for each assembly stage of the other component.

8. Device according to claim 1, wherein it is recorded in the databank for each assembly stage of a component whether it can be combined with an assembly stage of another component, if there is a relationship between the two components.

9. Device according to claim 1, wherein the device comprises a calculation unit connected to the databank, as well as with an output unit.

10. Device according to claim 9, wherein the assembly stages of the components out of which a complex object can be assembled can be calculated with the calculation unit.

11. Device according to claim 10, wherein, for an assembly stage of a component, the assembly stages of the remaining components of the complex object out of which said complex object can be assembled can be calculated with the calculation unit.

12. Device according to claim 1, wherein the successive assembly stages of a component are recorded in the databank.

13. Device according to claim 1, wherein the successive assembly stages of the complex object are recorded.

14. Method for administering data that are related to a complex object comprising a plurality of components when the complex object is modified, wherein at least a portion of the components goes through a series of assembly stages during this modification, wherein the interrelationships of the components are recorded in a databank for each assembly stage by means of relationship data.

15. Method according to claim 14, wherein the relationship data contain information on whether a component is attached to another component in the assembled complex object.

16. Method according to claim 14, wherein the relationship data contain information on whether a component possesses a surface that is contiguous with another component in the assembled complex object.

17. Method according to claim 14, wherein the relationship data contain information on whether a component is arranged in the vicinity of another component in the assembled complex object so that the modification of the first component affects the second component in the vicinity of the first component.

18. Method according to claim 15, wherein the information in the relationship data is recorded for each assembly stage of the one component and for each assembly stage of the other component.

19. Method according to claim 16, wherein the information in the relationship data is recorded for each assembly stage of the one component and for each assembly stage of the other component.

20. Method according to claim 17, wherein the information in the relationship data is recorded for each assembly stage of the one component and for each assembly stage of the other component.

21. Method according to claim 14, wherein it is recorded for each assembly stage of a component whether it can be combined with an assembly stage of another component, if a relationship exists between both components.

22. Method according to claim 14, wherein the assembly stages of the components out of which the complex object can be assembled are calculated.

23. Method according to claim 14, wherein the assembly stages of the remaining components of the complex object out of which said complex object can be assembled for an assembly stage of a component are calculated.

24. Method according to claim 14, wherein the successive assembly stages of a component are outputted.

25. Method according to claim 14, wherein the successive assembly stages of the complex object are outputted.
